(19) United States
(12) Patent Application Publication
(10) Pub. No.: US 2020/0394733 A1
(43) Pub. Date: Dec. 17, 2020

(54) SYSTEMS AND METHODS FOR MOBILE DEVICE-BASED LEGAL SELF HELP

(71) Applicant: Access to Justice, Inc., San Francisco, CA (US)

(72) Inventor: Case Lewis, San Francisco, CA (US)

(21) Appl. No.: 16/903,214

(22) Filed: Jun. 16, 2020

Related U.S. Application Data
(60) Provisional application No. 62/862,560, filed on Jun. 17, 2019.

(51) Int. Cl. G06Q 50/18; G06Q 10/10; G06Q 30/00; G06N 20/00; G06F 21/60

(52) U.S. Cl. CPC G06Q 50/18; G06Q 10/107; G06Q 30/018; G06F 40/174; G06F 21/602; G06Q 2220/00; G06N 20/00

(57) ABSTRACT

Automated mobile device-based legal self-help techniques are disclosed. An identification of a legal topic is received in an application on a mobile device. A first prompt for user input related to the legal topic is provided in the application. In response to the first prompt, first information related to the legal topic is received in the application. The first information is stored in a database on the mobile device. A second prompt for user input related to the legal topic is provided. Second information related to the legal topic is received in the application. A legal form or document is determined from a plurality of legal forms and documents based at least in part on the first information and second information. The legal form or document is updated using the first information and the second information.

### CROSS-REFERENCE TO RELATED APPLICATIONS

The present application claims priority to U.S. Provisional Patent Application No. 62/862,560, filed Jun. 17, 2019, the contents of which are incorporated herein in their entirety.

### TECHNICAL FIELD

The present disclosure relates to systems and methods to generate documents, and more specifically to automated generation of legal forms and documents on a mobile device.

### BACKGROUND

Computer assisted legal self-help techniques assist users in handling legal transactions. There are existing solutions that attempt to automate legal self-help, but the existing solutions may not meet the needs of the industry for various reasons. Many, for example, require a constant internet connection. Other solutions are insufficient because they do not function natively on smartphones, do not utilize the hardware features of a smartphones, do not securely maintain sensitive user data locally on the user's smartphone device, and/or do not provide a satisfactory user experience or functionality. There is a need for improved mobile device-based legal self help techniques.

### SUMMARY

Using the techniques described herein in various embodiments, legal forms and documents are generated on a mobile device. The techniques disclosed herein do not require a desktop or laptop computer. The techniques disclosed herein allow for generation of legal forms and documents without the need for a cellular, Wi-Fi, and/or other internet connection. The techniques disclosed herein addresses the aforementioned deficiencies by providing an intuitive and easily understood user experience, while assisting users with answering questions for legal forms and generating legal documents.

Disclosed herein are systems and methods to generate legal forms and documents on a mobile device. Various components that make up the architecture of the system include, for example, a mobile device (e.g., a smartphone) that runs software applications, a secure database for user specific data, legal form templates and document templates configured to accept data from the database, techniques to input user data into modified legal form and document templates, and user interfaces to guide a user in entering data that corresponds to specific components of complex legal forms or documents. These components may be structured such that the back end and associated processing are not apparent to the user, who sees only the user interface that assists them in answering prompts corresponding to content for the legal forms or documents. This architecture allows the system to automate the process of completing legal forms, automatically handling redundancies and calculations for the user, and for legal documents, selecting what template blocks are necessary for the user's document. In order to accomplish desired objectives, the system employs certain associated software that guides the user by providing hints and instructions to the user on how to answer specific questions. This software allows the users to fill out legal forms or documents on their smartphone with automated instruction and assistance, and then print out, email, text, e-file, or otherwise share these completed legal forms and documents in print or digital form.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The techniques disclosed herein, however, may be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF DRAWINGS

The foregoing and other features and advantages of the disclosure will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 is a block diagram illustrating embodiments of a system to automatically generate legal documents.

FIG. 2 is a flowchart illustrating embodiments of a process of automatically generating legal documents.

FIG. 3 is a flowchart illustrating a user authentication process according to various embodiments.

FIG. 4 is a flowchart illustrating embodiments of a process of determining an input method to automatically generate legal documents.

FIG. 5 is a flowchart illustrating embodiments of a process of using direct user input to automatically generate legal documents.

FIG. 6 is a flowchart illustrating embodiments of a process of using downloaded files to automatically generate legal documents.

FIG. 7 is a flowchart illustrating embodiments of a process of using camera scanned images to automatically generate legal documents.

FIG. 8 is a flowchart illustrating embodiments of finalizing and outputting automatically generated legal documents.

FIG. 9 is a diagram illustrating an application interface including multiple legal topics according to various embodiments.

FIG. 10 is a diagram illustrating an application interface including groups of information prompts according to various embodiments.

FIG. 11 is a diagram illustrating an application interface depicting the process of automatically generating legal documents.

FIG. 12 is a diagram illustrating an application interface to output automatically generated legal documents.

FIG. 13 is a diagram illustrating an application interface to output an automatically generated legal document.

FIG. 14 is a diagram illustrating an application interface to share automatically generated legal documents.

FIG. 15 is a block diagram illustrating an exemplary computer system used to perform the techniques disclosed herein.

### DETAILED DESCRIPTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

Any publications and references cited herein are hereby incorporated by reference in their entirety.

As used herein, the term “a” refers to one or more. The terms “including,” “for example,” “such as,” “e.g.,” “may be” and the like, are meant to include, but are not be limited to, the listed examples.

Disclosed herein are systems and computer-implemented processes. In various embodiments, the system includes one or more of the following: a mobile device (smartphone), a user interface, a database, legal forms, and/or documents to accept data input from the database. In various embodiments, a smartphone application, the software, offers instructions and accepts information input by the user into the user interface. The application saves this information into the database. A list of available of legal forms and documents are determined based on the input. The user provides data responsive to prompts, the data is stored in a database, the user requests legal forms or documents from the user interface, and the software inputs the saved data from the database into the legal forms, and prints, emails, texts, or otherwise shares the data laden legal forms or documents.

In various embodiments, the systems and methods may utilize one or more of the following functionalities: cloud-based data backup; digital signature for signing forms or documents within the smartphone application; e-filing for filing the legal forms or documents with a court, government agency, or similar entity from within the smartphone application; links to additional information or resources on the internet or by telephone from within the application; or by accessing separate smartphone capabilities such as a web browser, telephone, messaging app, or other feature; use of camera to capture data such as a signature or printed form data; use of optical character recognition or other techniques to input data captured by the camera or otherwise sent to the smartphone into the database; non-form legal documents, such as agreements, motions, pleadings, or other legal documents generated by the smartphone application; machine learning algorithms to assist the user with legal forms or other documents; artificial intelligence to assist the user with legal forms or other documents; fingerprint recognition or facial recognition to verify identity of the user, and/or other functionalities. In certain cases, the associated computerized process may also include one or more of the following executable steps: backup user data to cloud storage; digitally signing legal forms or documents; access smartphone feature, such as web browser, telephone, camera, or messaging app, and transfer data through it; transfer data to or from an external source, such as a process server or court e-filing service or server, in the form of raw data or data in the form of data-laden legal forms or documents; digital signature capture; printed form data capture subsequently processed through an optical character reader; alter user interface or legal document output based on machine learning algorithms; alter user interface or legal document output based on artificial intelligence; verify user identity by fingerprint or facial recognition data; and/or other steps.

In various embodiments, the disclosed systems provide comprehensive automated legal self-help on a smartphone platform. Similarly, the techniques disclosed are unique when compared with other known solutions in that it provides this comprehensive automated legal self-help as an intuitive and instructive user experience, leveraging the advanced hardware capabilities of smartphones to provide superior functionality, local database storage, faster responses, and a more streamlined, understandable and satisfactory user experience.

In various embodiments, the following beneficial features are provided: (1) a comprehensive, automated legal self-help system native to a smartphone device; (2) sensitive user data is written to a database, encrypted, and/or contained within the user's mobile device; (3) hardware capabilities of the mobile device are utilized to speed and assist the form and document completion process and provide a superior user experience and functionality; and (4) machine learning and artificial intelligence assist user's with drafting legal documents. Similarly, the associated software is unique in that is incorporates the smartphone device saving data to a local database; writing data to the database from user inputs, camera input with or without optical character reading, or downloaded file inputs; protecting sensitive user data and digital signature with native smartphone hardware fingerprint or facial recognition; altering document templates based on machine learning algorithms and artificial intelligence and generating legal documents unique to the user.

In various embodiments, the system is made up of the following components: a mobile device, an instructive user interface, a database contained within the mobile device with redundant cloud-based backup, legal forms to accept data input from the database, a digital signature of the user's saved into the database for signing forms or documents within the smartphone application, e-filing capability and connected online service for filing the legal forms or documents with a court from within the smartphone application, in-app links to additional information or resources on the internet or by telephone from within the application, or by accessing separate smartphone capabilities such as a web browser, telephone, messaging app, or other feature, use of camera to capture data such as a signature or printed form data, an optical character reader capability to input data captured by the camera into the database, a download capability to allow data otherwise sent to the smartphone to be entered into the database, template non-form legal documents, such as agreements, motions, pleadings, or other legal documents altered and generated by the smartphone application after receiving user input saved into the database, machine learning algorithms to alter the non-form legal document templates and otherwise assist the user with legal forms or other documents, artificial intelligence to alter the non-form legal document templates and assist the user with legal forms or other documents, fingerprint recognition or facial recognition to verify identity of the user depending on the hardware capabilities of the user's individual smartphone.

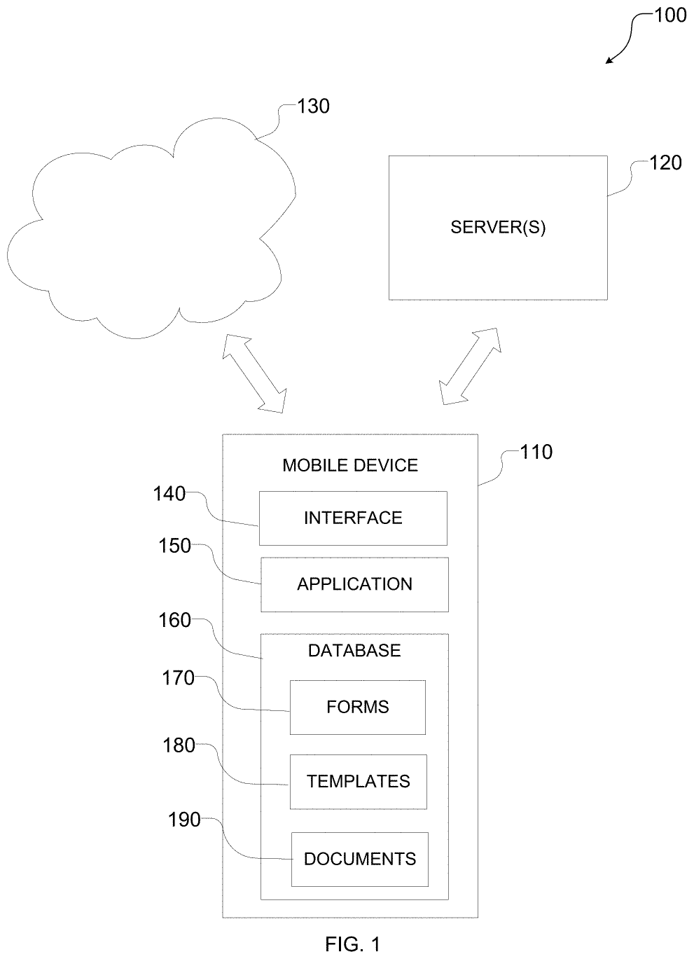

FIG. 1 is a block diagram illustrating embodiments of a system to automatically generate legal documents. In the example shown, a system 100 includes a mobile device 110, one or more servers 120, Internet-accessible services 130, and/or other elements. The remote servers 120 may include a cloud storage, application servers, storage repositories, and/or other server components. The mobile device 110 may include an interface 140, a mobile device application 150, databases 160, and/or other elements. The interface 140 may include a touch screen interface that allows for data input and output. The interface 140 may guide a user through prompts and input interfaces to create legal forms or documents as described herein. The interface 140 may be associated with an application 150. The application 150 may include a mobile device application configured to assist with the generation of legal forms or documents as disclosed herein. The application 150 controls the interface 140 and the writing of data to the database 160. Data captured in the interface 140 may be stored in the database 160. For example, data written to the database 160 may be input by the user directly into the interface 140, captured by camera associated with the mobile device 110 and input as an image or processed by an optical character reader associated with the application 150, downloaded from an external source, and/or otherwise input. The application 150 may respond to user commands in the interface 140 to read data from database 160 and input that data into legal forms 170, document templates 180, and/or other locations.

In certain cases, machine learning algorithms and artificial intelligence adjust the output of document templates 180 by presenting the user with different template blocks based on data input by the user to the database. The machine learning algorithms may be trained on predefined sets of data, on multiple user data sets across various mobile devices and updated with application updates, and/or using other techniques apparent to those of skill in the art. Machine learning and artificial intelligence techniques adjust the interface 140 based on the algorithms training data and data input by the user to the database 160. The application 150 may allow the user, through the interface 140, to digitally sign the legal form 170 or other document 190 and e-file, print, email, text, or otherwise share the completed, digitally signed legal form 170 or other documents 190. It should further be noted that certain features such as downloading data for sharing prepared legal forms 170 or documents 190 requires a connection to an external network such as an internet connection or to an external device, such as a printer.

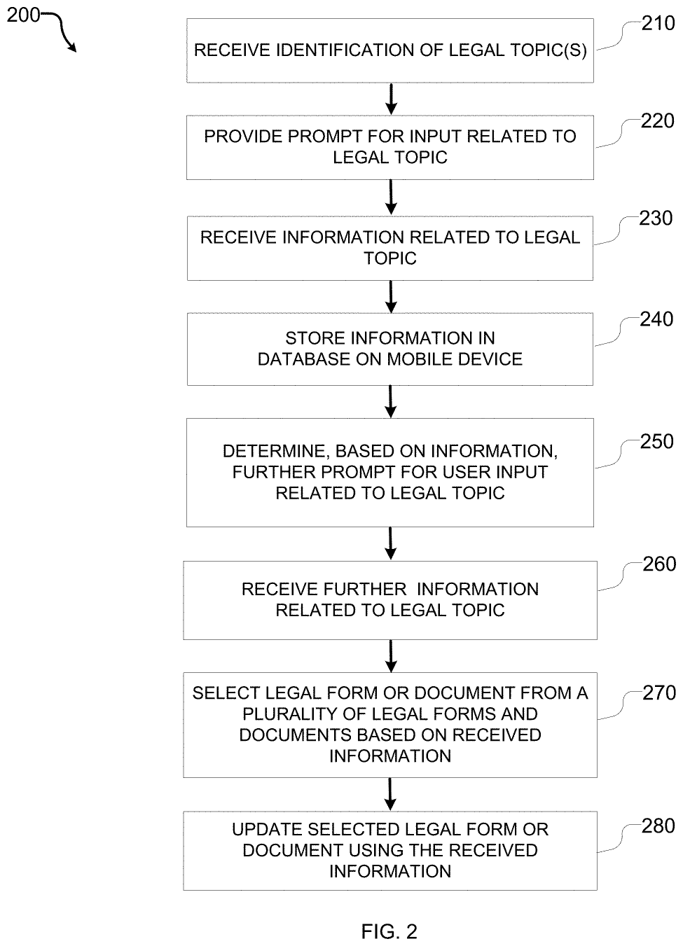

FIG. 2 is a flowchart illustrating embodiments of a process of automatically generating legal documents. An exemplary process 200 of generating legal forms and documents is shown. A user may access the application via a mobile device. At 210, an identification of one or more legal topics is received. For example, a user may be presented a list of legal topics available on the platform. Legal topics may include, for example, marital law (divorce/legal separation, support payments), estate planning (advance health care directives, wills, trusts, and the like), corporate (business entity registration), and/or any other legal topics. The user may select a legal topic. At 220, prompts for input related to the legal topic are provided. For example, fields may be provided for the user to enter various information related to the user and/or the legal topic. Similarly, pull down menus, buttons, and/or other interface items prompting information from the user may be provided. At 230, information related to the legal topic is received. The user may provide information in response to the output prompts. For example, the user may provide personal information, legal information, and/or other information in response to the prompts. At 240, the information is stored in a database on the mobile device. The application may write the information to storage on the mobile device. In certain cases, the information stored on the mobile device is encrypted, stored in encrypted storage, password-protected, and/or otherwise secured on the mobile device. At 250, further prompts for input related to the legal topic are determined based on the information received from the user. Further prompts may be dependent on information provided by the user in response to previous prompts. Information provided by a user may affect the type of legal forms or documents appropriate to the user's needs. Information provided in response to a prompt may, for example, render certain legal forms or documents irrelevant and other documents relevant. The further prompts determined and output to a user may be related to legal forms and/or documents determined to be relevant. The determination of further prompts may be performed transparent to the user. The user may, for example, not be able to determine (it may not be apparent to the user) that the application is determining further prompts.

At 260, further information related to the legal topic is received. The user may provide information in response to the further prompts output at step 250. For example, the user may provide further personal information, legal information, and/or other information. The process of prompting the user for information, storing received information, and determining additional prompts may be repeated. At 270, one or more legal forms or documents are selected based on information received from the user. The information received from the user in response to the prompts may be relevant to one or more documents, and the relevant documents are identified. Further prompts to complete the necessary fields of the selected legal forms or documents may be output. In certain cases, the determination and/or selection of legal forms or documents may be performed transparent to the user. The user may, for example, not be able to determine (e.g., it may not be apparent to the user) that the application is determining and/or selecting legal forms based on information from the user. In certain cases, the determination and/or selection of legal forms or documents is performed using machine learning, artificial intelligence, and/or similar techniques. At 280, the selected legal forms or documents are updated to include the information provided by the user. After providing information in response to the prompts, the user may select one or more of the legal forms or documents for output. Upon selection, the legal forms or documents may be updated to include the information received from the user and stored in the database on the mobile device. The selected legal forms or documents may be output via text, email, printing, and/or other techniques disclosed herein. The selected legal forms or documents may be output for storage at a remote storage, such as in cloud storage, at a remote server, and/or another location. In certain cases, the legal forms or document may be automatically transmitted to an entity, such as servers associated with a government agency.

In various embodiments, one or more of the following steps may be performed. Prompts for information of the user are output in the application interface. The user provides information in the application interface in response to the prompts. The information input into the application interface is written to a database on the mobile device, encrypted, and/or otherwise secured. The information may be backed-up to remote cloud storage. Specific information may be retrieved from the database according to selections by user in user interface. The specific information is written from the database into legal forms and documents.

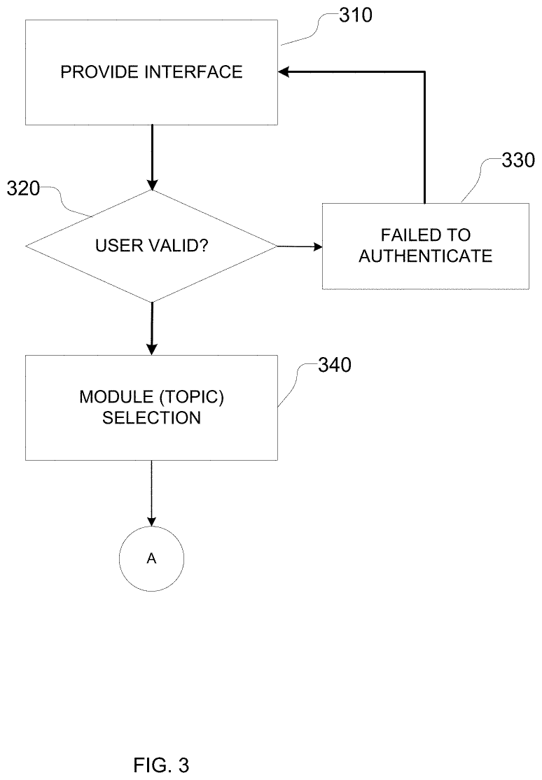

FIGS. 3-7 are flowcharts illustrating embodiments of a process of receiving and processing input to automatically generate legal documents. FIGS. 3-7 may include sub-steps in the process of receiving and processing input to automatically generate legal forms and documents using a mobile device. In various embodiments, the processes are performed by the system 100 of FIG. 1.

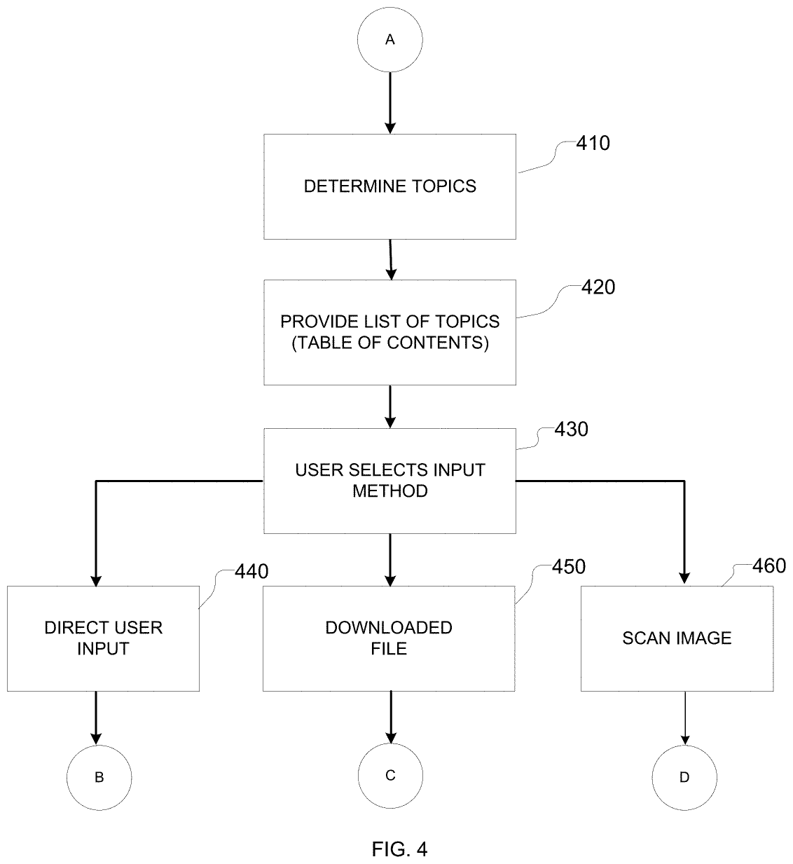

FIG. 3 is a flowchart illustrating a user authentication process according to various embodiments. At 310, an interface is provided in a mobile application. The interface may allow the user to provide credential information, such as a name, address, username, password, fingerprint, face image, and/or other similar authentication information. Upon first using the application, a user may establish credential information and an account with the platform. At 320, the credential information is analyzed to determine if the user is valid. For example, if the user has previously registered with the application and correctly enters their credential information, then the user would be validated at the process proceeds to step 340. When the user does not provide correct credential information, an authentication failure occurs (330) and the user is returned to the authentication interface (310). At step 340, the process proceeds to determining a module topic, as described, for example, with reference to FIG. 4.

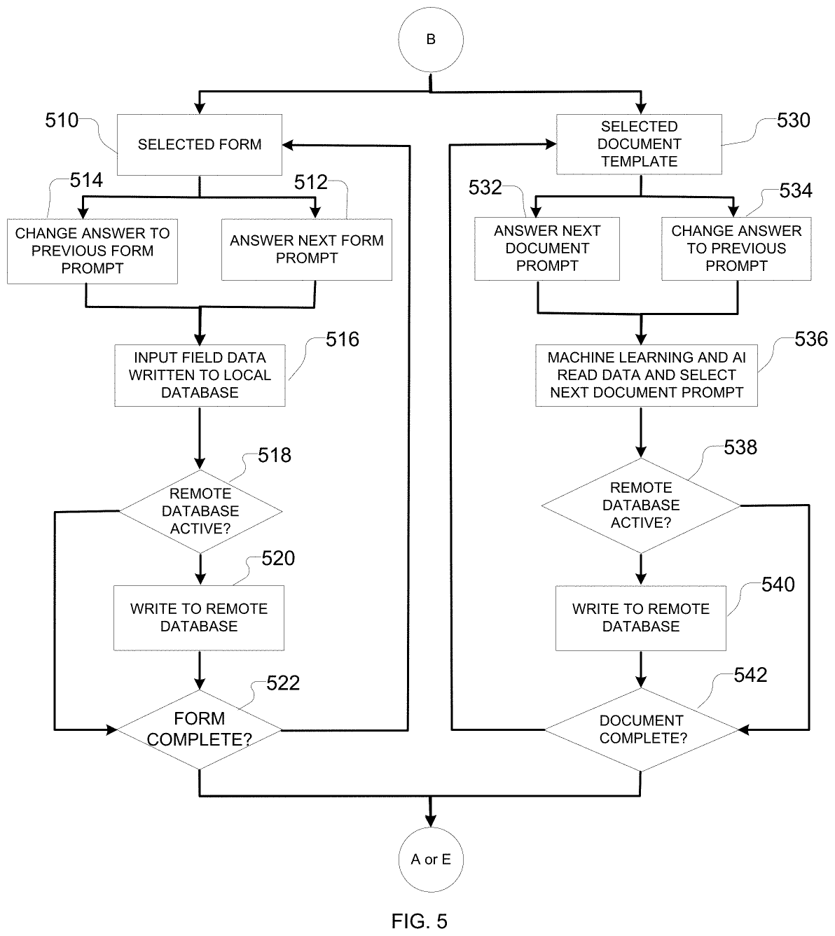

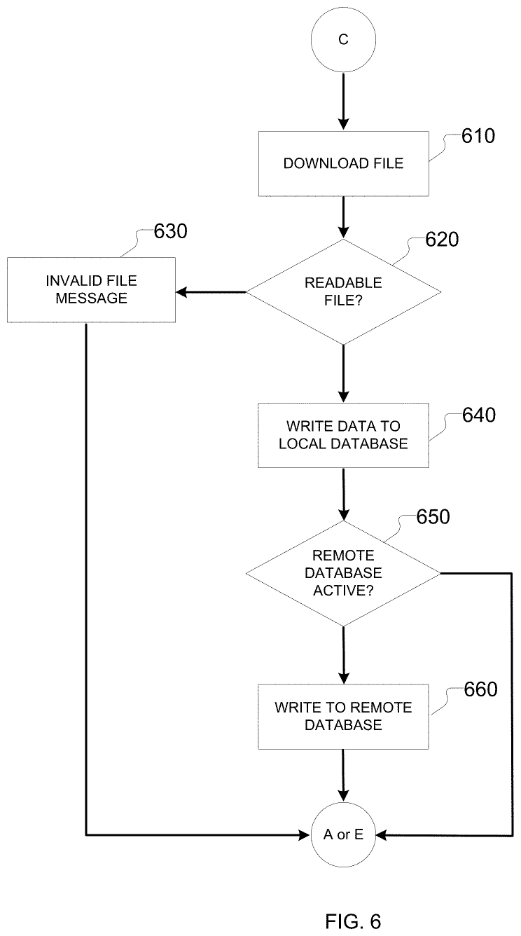

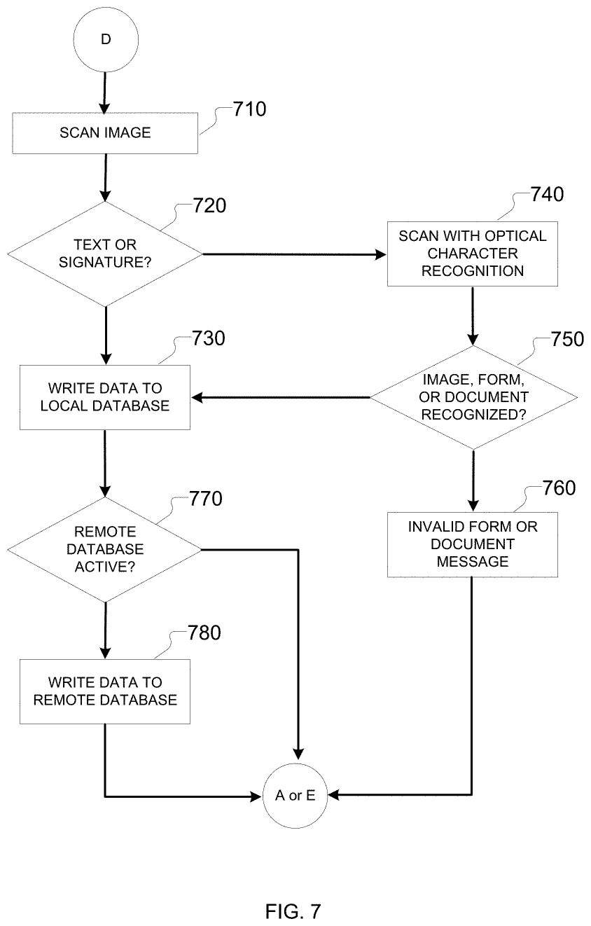

FIG. 4 is a flowchart illustrating embodiments of a process of determining an input method to automatically generate legal documents. In various embodiments, the process of FIG. 4 may continue from the process at step 340 of FIG. 3, as depicted by the step denoted A. At 410, one or more topics are determined. The topics may include, for example, areas of law, categories of legal documents, and/or similar groups of information. Example topics include fee waiver documents, advance health care directive documents, name change documents, divorce/legal separation documents, support payments documents, eviction defense documents, business formation documents, and/or other types of documents. The application may check session variables in a database on the mobile device and display available topics (e.g., groups of forms or documents). The session variables may include, for example, available topics, attributes of the user (such as age, gender, marital status, legal status, and/or similar attributes), and/or any other variables. The variables may determine the topics available in the application. At 420, topics are output to the user. The application interface may, for example, output a list of available topics to the user. A user may select a topic. At 430, an input method is selected or automatically determined. In certain cases, a user may select an input method. In certain instances, an input method may be automatically determined based on, for example, user attributes, files stored on the mobile device, mobile device capabilities, and/or other information. In certain cases, a direct user input method is selected, and the process proceeds to step 440. Step 440 is described in detail in, for example, FIG. 5. In certain cases, a downloaded file input method is selected, and the process proceeds to step 450. Step 450 is described in detail in, for example, FIG. 6. In certain cases, a camera scan input method is selected, and the process proceeds to step 460. Step 460 is described in detail in, for example, FIG. 7.

FIG. 5 is a flowchart illustrating embodiments of a process of using direct user input to automatically generate legal documents. In the example shown, processes of automatically preparing legal documents using forms or document templates are depicted. During input, form or document values and session, progress, or template block values are written into the database and read at each subsequent step to control what is displayed to the user and carefully guide the user through the process.

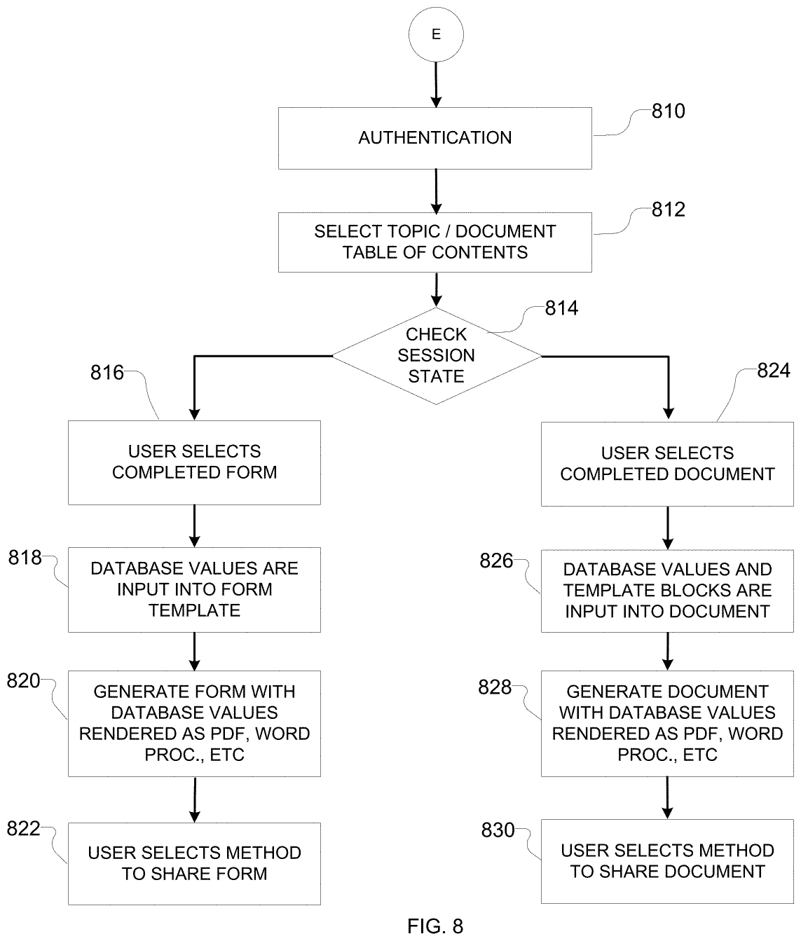

At 510, legal form is selected. A form may include a predefined file to be populated based on user input. A form may include fields to be filled in during document creation. The system may select a legal form based on a selected legal topic, information known about the user, and/or other information. For example, the form may be selected based on variables associated with user, such as age, address, location, legal status, and the like, variables associated with the platform, and/or other variables. In certain cases, the user may select the form to be populated. In certain cases, the application and/or system selects the form to be populated. At 512, a form prompt is presented to the user. The prompt may correspond to a next portion of a form to be completed. In certain cases, a prompt may be presented in the form of a button, question, pull down menu, or other interface to enter information. At 514, a user may change an answer to a prompt by, for example, providing an updated response to a previously completed question, selecting a different item in a pull-down menu, or an updated response to a pre-populated prompt. At 516, data received in response to the prompt is written to a local database on, for example, the mobile device. At 518, it is determined whether to write the data responsive to the prompt to a remote database. The remote database may be active or not active based on settings in the application. In certain cases, for security and user privacy the data received from the user is not stored in a remoted database and is only stored on the mobile device database. If the remote database is active, the process proceeds to step 520. At 520, the input field data is stored in the remote database. If the remote database is not active, input field data is not stored remotely, and the process proceeds to step 522. At 522, it is determined whether the form is complete. The form may be complete if the application determines that all form prompts required to complete and/or substantially complete the form have been answered. If the form is not complete, the process proceeds to step 510 and additional prompts are provided to the user, and additional information responsive to the questions is received. The additional form questions presented to the user may be determined based on the data previously provided in the input field data in response to previous prompts. If the form is complete, the process proceeds to either the process depicted in FIG. 4, the document or form output process depicted in FIG. 8, and/or another process.

At 530, a document template is selected. A document template may include an outline or shell of a legal document, such as a contract, pleading, agreement, and/or other document affecting legal rights or position of a user or entity. A document may include fewer if any designated fields. More sophisticated processing techniques, such as artificial intelligence, machine learning, and structured tree-related processing are used to prompt information from the user, format the information, and input the formatted information into a document. At 532 and 534, a series of prompts are presented to the user. At 532, a document prompt is presented to the user. The prompt may correspond to one or more portions of a document. A prompt and responses thereto may affect the ultimate content of a document. At 534, a user may change an answer to a prompt previously presented. For example, a user may navigate back to a previously answered prompt and change or update an answer to a previous prompt. At 536, machine learning, artificial intelligence, computer logic, and/or other processing is applied to data entered in response to the prompt. Based on the processing, a next prompt is determined. The next prompt may include a prompt for a user to enter information necessary to complete a further portion of document. The next prompt may logically extend from the previous prompts and the user's responses to the previous prompts. In one example, a tree is traversed to identify a next appropriate prompt output to the user. Various document types may be arranged in a tree structure (in for example, the database on the mobile device), and the ultimate form of the document and its content is determined by traversing the tree based on user responses to the prompts. For example, the particular path to traverse the tree and associated determinations of document content are based on the user's responses to the output prompts. In another example, machine learning and/or artificial intelligence are employed to evaluate previous responses to prompts and determine an appropriate next prompt to be output to a user. Using artificial intelligence techniques a decision tree is generated including may possible permutations of legal form or document elements, with many branches differing in certain case slightly. The artificial intelligence techniques traverse the tree based on input received from the user. Using machine learning the decision trees are populated without the need to code every permutation of a document.

Data received in response to the prompt is written to a local database on, for example, the mobile device. At 538, it is determined whether to write the data responsive to the prompt to a remote database. The remote database may be active or not active based on settings in the application. In certain cases, for security and user privacy the data received from the user is not stored in a remoted database and is only stored on the mobile device database. If the remote database is active, the process proceeds to step 540. At 540, the data received in response to the prompt is stored in the remote database. If the remote database is not active, the prompt data is not stored remotely, and the process proceeds to step 542. At 542, it is determined whether the document is complete. The document may be complete if the application determines that all necessary information to complete and/or substantially complete the document has been provided. If the document is not complete, the process proceeds to step 530 and additional prompts are provided to the user. The additional prompts may have been determined in step 536. If the document is complete, the process proceeds to either the process depicted in FIG. 4 to assess whether further documents are to be created, the document or form output process depicted in FIG. 8, and/or another process.

FIG. 6 is a flowchart illustrating embodiments of a process of using downloaded files to automatically generate legal documents. In the example shown, processes of automatically preparing legal forms or documents using data from downloaded files are described. At 610, a file is downloaded. The file may include a legal form, a document, a spreadsheet, data, a scanned image, and/or any other file including legal information. The file may include information that can be extracted, stored in the database, and used to populate a legal form, legal document, and/or other document. At 620, it is determined whether the file is readable. A file may readable if it is in a format conducive to extraction of data. If the file is not readable, the process proceeds to step 630 and an invalid file message is output (630). Upon display of an invalid file message (630), the process proceeds to FIG. 4 and additional types of data entry may be evaluated. If the file is readable, the process proceeds to step 640, and the contents of the file are extracted. At 640, the extracted data is added to the local database. At 650, it is determined if the remote database is active and whether to write the data to a remote database using the techniques described with reference to FIGS. 4 and 5. If the remote database is active, the process proceeds to step 660. At 660, the data extracted from the file is stored in the remote database. If the remote database is not active, the prompt data is not stored remotely, and the process proceeds to the steps described on FIG. 4.

FIG. 7 is a flowchart illustrating embodiments of a process of using camera scanned images to automatically generate legal documents. In the example shown, processes of automatically preparing legal forms or documents using data from images captured using a camera associated with the mobile device, a scanner, and/or another image capture tool are disclosed. At 710, images are captured and provided to the application. At 720, it is determined whether the image includes a signature, text, or other information. If the image includes a signature, the process proceeds to step 730. If the image includes text, the process proceeds to step 740. At step 740, the image is a scanned with an optical reader. Optical character recognition (OCR) may convert any images into text. At 750, the optical character recognition processed text from the image is analyzed to determine if the content is recognized. The content may, for example, be compared to a dictionary of terms to identify whether the content is relevant to the completion of legal forms and documents. If the content is not recognized, the process proceeds to step 760 and error message indicating invalid form or document is output. If the image, form, or document is recognized, the process proceeds to step 730. At step 730, the recognized data extracted from the image, form, or document is added to the local database on the mobile device. In certain cases, the recognized data is filtered to identify information relevant to the population of legal form and/or document. For example, machine learning, artificial intelligence, text recognition, and/or other techniques may be applied to identify relevant text from extracted images. Relevant information may include information about a person, entity, and/or other subject of a legal form or document. Relevant information may be determined based on the type of legal form or document being generated. For a certain type of legal form or document, particular types of information may be relevant. The types of relevant information may be stored, for example, in a library. Any relevant information identified in the optical character recognition processed images, forms, and/or documents may be stored in the database. Signature information identified, for example, in step 720 may also be stored in the local database.

At 770, it is determined if the remote database is active and it is determined whether to write the OCR captured data to a remote database using the techniques described with reference to FIGS. 4 and 5. If the remote database is active, the process proceeds to step 780. At 780, the OCR-extracted data is stored in the remote database. If the remote database is not active, the extracted data is not stored remotely, and the process proceeds to the steps described on FIG. 4.

FIG. 8 is a flowchart illustrating embodiments of finalizing and outputting automatically generated legal documents. The processes described with reference to FIG. 8 are used to complete and output legal forms, documents, and the like. In certain cases, the processes of FIG. 8 may occur or be performed after the processes of FIGS. 3-7. For example, once a legal form, document, or similar instrument is generated using one or more of user input (FIG. 5), a downloaded file (FIG. 6), scanned image (FIG. 7), and/or other techniques, a document is finalized using the techniques described in FIG. 8. At 810, a user is authenticated. A user may be authenticated using the techniques described in FIG. 3. At 812, a legal topic is selected. At 814, a session state is checked, and any completed legal forms, documents, and like associated with the topic are displayed to the user. At 816, a user is presented a list of legal forms, and a legal form is selected. At 818, database values are input into the form template. For example, data is collected from a database on the mobile device. The data may be collected and stored in the database using the techniques described with reference to FIGS. 3-7. Upon selection of a legal form, the database is queried to retrieve data, and the data is used to populate the selected legal form. At 820, a legal form is populated and finalized using the data retrieved from the database. The user may be provided an option to select the type of completed document, such as PDF, word processor document, JPEG, and/or any other format. At 822, a user may select a method to share the legal form, such as via text, email, printing, and/or other methods.

In the event the user selects a legal document at step 814, the process may proceed to steps 824-830. Steps 824-830 may be similar to steps 816-822.

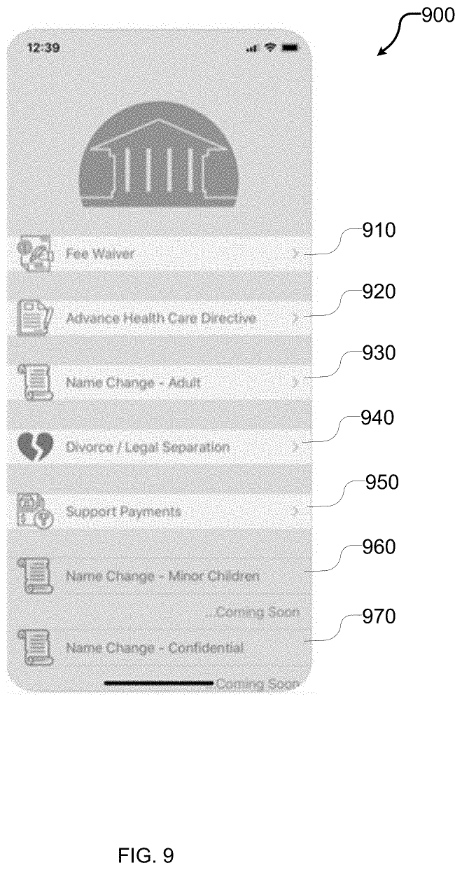

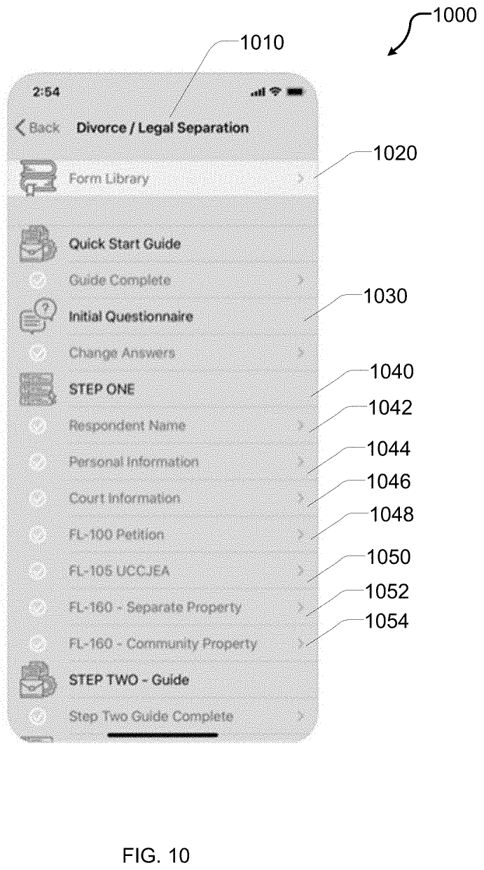

FIG. 9 is a diagram illustrating an application interface including multiple legal topics according to various embodiments. In the example shown, application interface 900 includes multiple legal topics. As depicted, legal topics may include fee waiver 910, advance health car directive 920, name change—adult 930, divorce-legal separation 940, support payments 950, name change—minor children 960, name change—confidential 970, eviction defense, business formation, and/or any other legal topics. A user may select one of the legal topics, and upon selection be directed to an interface associate with that topic. For example, a user may select divorce/legal selection, and the application may direct the user to the interface depicted in FIG. 10.

FIG. 10 is a diagram illustrating an application interface including groups of information prompts according to various embodiments. In the example shown, an interface 1000 include multiple groups of information prompts related to a legal topic. The legal topic 1010 shown in this example is divorce/legal separation. The multiple groups include a form library 1020. The form library 1020 may be updated when a user has provided information and the information is stored in the database as described, for example, in FIGS. 3-7. A user may provide information in a series of questionnaires 1030 including one or more question prompts, data fields, buttons, and/or other input mechanisms. A step one questionnaire 1040 may include groups of prompts related to the case, such as, for example, a respondent name 1042, personal information 1044, court information 1046, FL-100 petition prompts 1048, FL-105 UCCJEA prompts 1050, FL-160—separate property prompts 1052, FL-160—community property prompts 1054, and/or other groups of prompts. A user's responses to each sets of prompts may dictate the display of additional prompts. Which prompts and groups of prompts are displayed may be determined based on, for example, traversal of tree structure, machine learning, artificial intelligence, and/or other techniques.

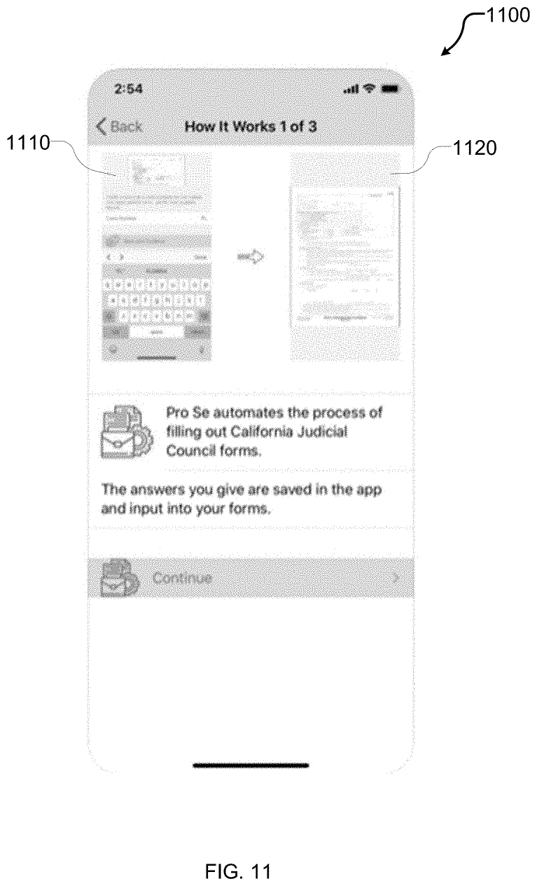

FIG. 11 is a diagram illustrating an application interface depicting the process of automatically generating legal documents. In the example shown, the interface 1100 provides instructions 1110 on entering data in response to one or more prompts. The collected data is used to automatically generate one or more legal forms or documents 1120.

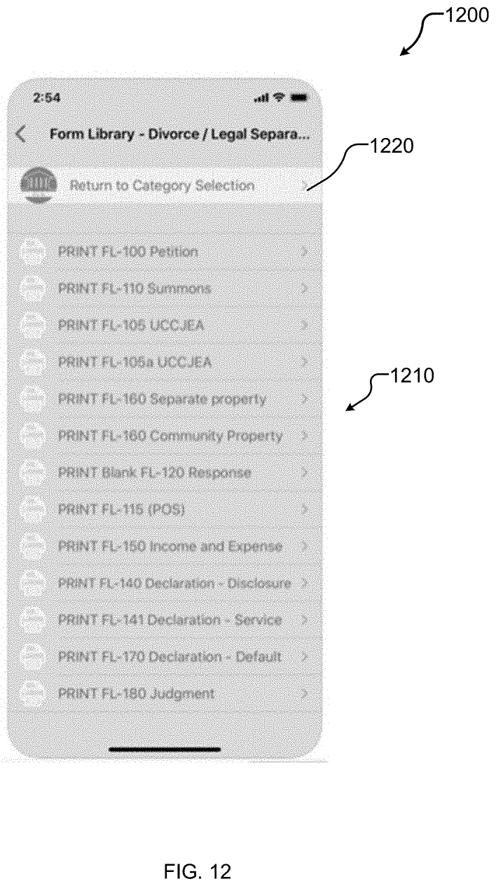

FIG. 12 is a diagram illustrating an application interface to output automatically generated legal documents. In the example shown, an application interface 1200 includes is a list of legal forms and/or documents. The legal forms and documents 1210 available for output include an FL-100 Petition, FL-110 Summons, FL-105 UCCJEA, FL-105a UCCJEA, FL-160 Separate property, FL-160 Community property, FL-120 Response, FL-115 (POS), FL-150 Income and Expense, FL-140 Declaration—Disclosure, FL-141 Declaration—Service, FL-170 Declaration—Default, FL-180 Judgment, and/or other forms. At this stage in the exemplary process, the use has provided information either by user input (FIG. 5), a downloaded file (FIG. 6), scanned image (FIG. 7), and/or other techniques. The information is stored in a database on the device and used to populate the legal forms and documents. A user may select one of the forms for output. A link 1220 is also provided for the user to return to the legal topic selection.

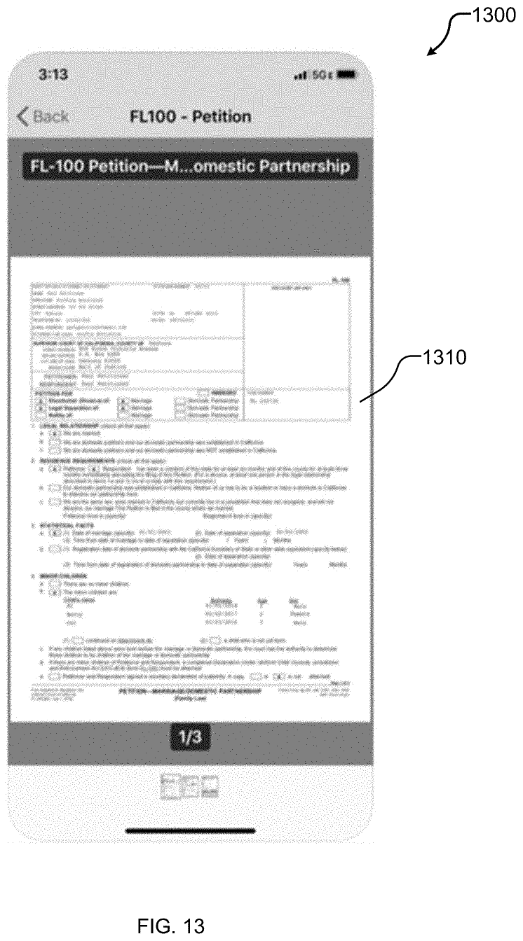

FIG. 13 is a diagram illustrating an application interface to output an automatically generated legal document. In the example shown, an interface 1300 includes a document prepared for output. The document 1310 in this example includes a FL-100 Petition. The document is completed based on the information provided from the user in previous steps as described herein. The document may be output as a PDF file, word processing documents, images, and/or another format.

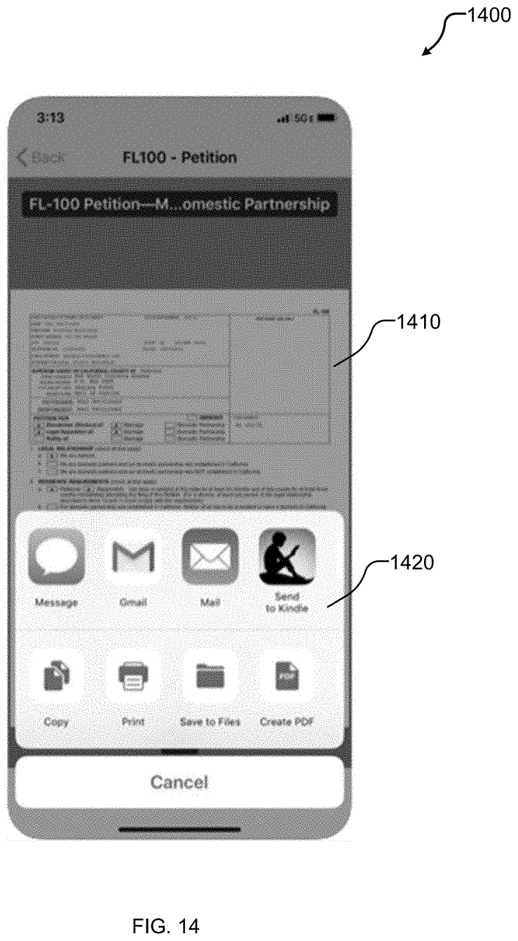

FIG. 14 is a diagram illustrating an application interface to share automatically generated legal documents. In the example shown, an interface 1400 includes a document or legal form 1410 prepared for output and a menu 1420 providing options to share the document or legal form. For example, the document or legal form 1410 may be shared via text, email, an eBooks service, printing, storage to a remote location, or similar techniques.

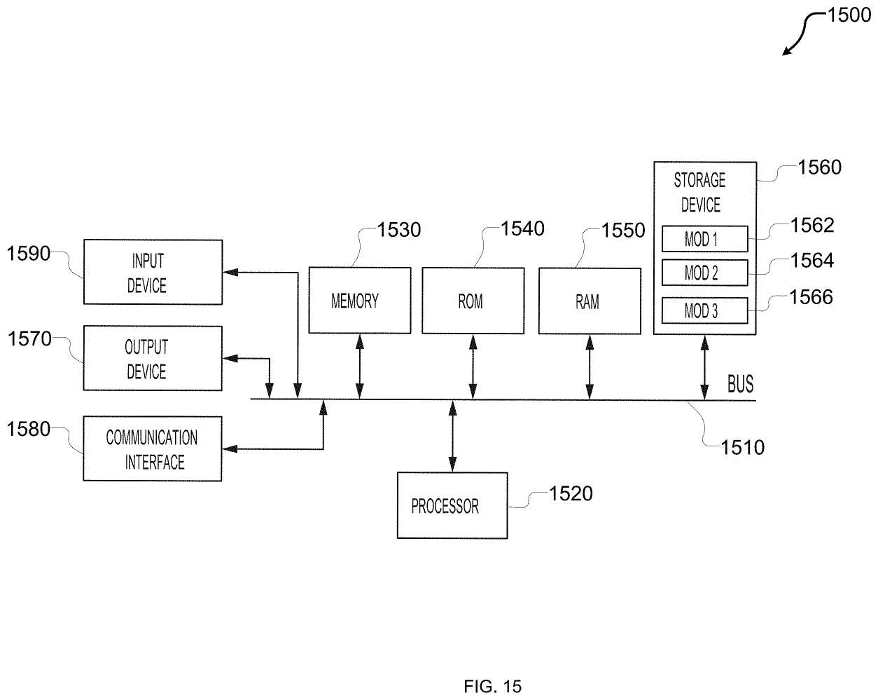

FIG. 15 is a block diagram illustrating an exemplary computer system used to perform the techniques disclosed herein. With reference to FIG. 15, an exemplary system 1500 may include computing device, including a processing unit (CPU or processor) 1520 and a system bus 1510 that couples various system components including the system memory 1530 such as read-only memory (ROM) 1540 and random-access memory (RAM) 1550 to the processor 1520. The system 1500 may include a mobile device (e.g., a smart phone, computing device) including applications, telecommunications capabilities, and/or other components. The system 1500 may also include servers, cloud computing components, and/or other computing devices. The system 1500 can include a cache of high-speed memory connected directly with, in close proximity to, or integrated as part of the processor 1520. The system 1500 copies data from the memory 1530 and/or the storage device 1560 to the cache for quick access by the processor 1520. In this way, the cache provides a performance boost that avoids processor 1520 delays while waiting for data. These and other modules can control or be configured to control the processor 1520 to perform various actions. Other system memory 1530 may be available for use as well. The memory 1530 can include multiple different types of memory with different performance characteristics. It can be appreciated that the disclosure may operate on a computing device 1500 with more than one processor 1520 or on a group or cluster of computing devices networked together to provide greater processing capability. The processor 1520 can include any general-purpose processor and a hardware module or software module, such as module one 1562, module two 1564, and module three 1566 stored in storage device 1560, configured to control the processor 1520 as well as a special-purpose processor where software instructions are incorporated into the actual processor design. The processor 1520 may essentially be a completely self-contained computing system, containing multiple cores or processors, a bus, memory controller, cache, etc. A multi-core processor may be symmetric or asymmetric.

The system bus 1510 may be any of several types of bus structures including a memory bus or memory controller, a peripheral bus, and a local bus using any of a variety of bus architectures. A basic input/output (BIOS) stored in ROM 1540 or the like, may provide the basic routine that helps to transfer information between elements within the computing device 1500, such as during start-up. The computing device 1500 further includes storage devices 1560 such as a hard disk drive, a magnetic disk drive, an optical disk drive, tape drive, or the like. The storage device 1560 can include software modules 1562, 1564, 1566 for controlling the processor 1520. Other hardware or software modules are contemplated. The storage device 1560 is connected to the system bus 1510 by a drive interface. The drives and the associated computer-readable storage media provide nonvolatile storage of computer-readable instructions, data structures, program modules and other data for the computing device 1500. In one aspect, a hardware module that performs a particular function includes the software component stored in a tangible computer-readable storage medium in connection with the necessary hardware components, such as the processor 1520, bus 1510, display 1570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1500 is a small, handheld computing device, a desktop computer, or a computer server.

Although the exemplary embodiment described herein employs the hard disk 1560, other types of computer-readable media which can store data that are accessible by a computer, such as magnetic cassettes, flash memory cards, digital versatile disks, cartridges, random access memories (RAMs) 1550, and read-only memory (ROM) 1540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1500, an input device 1590 represents any number of input mechanisms, such as a microphone for speech, a touch-sensitive screen for gesture or graphical input, keyboard, mouse, motion input, speech and so forth. An output device 1570 (display) can also be one or more of a number of output mechanisms known to those of skill in the art. In some instances, multimodal systems enable a user to provide multiple types of input to communicate with the computing device 1500. The communications interface 1580 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of is not intended to convey a requirement that each possible item must be present.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A computer-implemented method, comprising:
receiving, in an application on a mobile device, an identification of a legal topic;
providing, in the application, a first prompt for user input related to the legal topic;
receiving, in the application and in response to the first prompt, first information related to the legal topic;
storing the first information in a database on the mobile device;
providing, based at least in part on the first information, a second prompt for user input related to the legal topic;
receiving, in the application, second information related to the legal topic;
determining a legal form or document from a plurality of legal forms and documents based at least in part on the first information and second information; and
updating the legal form or document using the first information and the second information.

2. The computer-implemented method of claim 1, wherein determining the legal form or document from the plurality of legal forms is performed transparent to the user of the application.

3. The computer-implemented method of claim 1, wherein determining the legal form or document from the plurality of legal forms is performed using machine learning and artificial intelligence.

4. The computer-implemented method of claim 1, wherein the first information, the second information, and the legal form or document are not stored outside of the mobile device.

5. The computer-implemented method of claim 1, wherein the first information, the second information, and the legal form or document are stored in encrypted storage on the mobile device.

6. The computer-implemented method of claim 1, further comprising outputting the legal form or document using one or more of text, email, and remote storage.

7. The computer-implemented method of claim 1, further comprising automatically transmitting the legal form to an entity.

8. The computer-implemented method of claim 1, one or more of the steps of providing the first prompt, determining the second prompt, and selecting the legal form are performed using artificial intelligence.

9. A system comprising:
a processor; and
a computer-readable storage medium having instructions stored which, when executed by the processor, cause the processor to perform operations comprising:
receiving, in an application on a mobile device, an identification of a legal topic;
providing, in the application, a first prompt for user input related to the legal topic;
receiving, in the application and in response to the first prompt, first information related to the legal topic;
storing the first information in a database on the mobile device;
providing, based at least in part on the first information, a second prompt for user input related to the legal topic;
receiving, in the application, second information related to the legal topic;
determining a legal form or document from a plurality of legal forms and documents based at least in part on the first information and second information; and
updating the legal form or document using the first information and the second information.

10. The system of claim 9, wherein selecting the legal form or document from the plurality of legal forms is performed transparent to the user of the application.

11. The system of claim 9, wherein selecting the legal form or document from the plurality of legal forms is performed using machine learning and artificial intelligence.

12. The system of claim 9, wherein the first information, the second information, and the legal form or document are not stored outside of the mobile device.

13. The system of claim 9, wherein the first information, the second information, and the legal form or document are stored in encrypted storage on the mobile device.

14. The system of claim 9, further comprising outputting the legal form or document using one or more of text, email, and remote storage.

15. The system of claim 9, further comprising automatically transmitting the legal form to an entity.

16. The system of claim 9, one or more of the steps of providing the first prompt, determining the second prompt, and selecting the legal form are performing using artificial intelligence.

17. A non-transitory computer-readable storage medium having instructions stored which, when executed by a computing device, cause the computing device to perform operations comprising:
receiving, in an application on a mobile device, an identification of a legal topic;
providing, in the application, a first prompt for user input related to the legal topic;
receiving, in the application and in response to the first prompt, first information related to the legal topic;
storing the first information in a database on the mobile device;
providing, based at least in part on the first information, a second prompt for user input related to the legal topic;
receiving, in the application, second information related to the legal topic;
determining a legal form or document from a plurality of legal forms and documents based at least in part on the first information and second information; and
updating the legal form or document using the first information and the second information.

18. The non-transitory computer-readable storage medium of claim 17, wherein selecting the legal form or document from the plurality of legal forms is performed transparent to the user of the application.

19. The non-transitory computer-readable storage medium of claim 17, wherein selecting the legal form or document from the plurality of legal forms is performed using machine learning and artificial intelligence.

20. The non-transitory computer-readable storage medium of claim 17, wherein the first information, the second information, and the legal form or document are not stored outside of the mobile device.
